(19) United States
(12) Patent Application Publication
(10) Pub. No.: US 2008/0071591 A1
(43) Pub. Date: Mar. 20, 2008

(54) R&D productivity at the portfolio and program levels

(76) Inventor: Thomas W. Keelin, Menlo Park, CA (US)

Correspondence Address: DLA Piper US LLP, Suite 800, 153 Townsend Street, San Francisco, CA, 94107-1957, US

(21) Appl. No.: 11/523,390

(22) Filed: Sep. 19, 2006

(51) Int. Cl. G06F 17/50

(52) U.S. Cl. 705/7

(57) ABSTRACT

Methods of doing business and systems for implementing those methods which improve the effectiveness and success of research and development (R&D) in technical areas such as drug development, pharmaceuticals and biotechnology, are described. The methods provide for improved productivity of R&D by managing progress of drug development programs and portfolios of programs.

### FIELD OF THE INVENTION

This invention relates generally to methods of doing business and systems for implementing those methods which improve the effectiveness and success of the research and development (R&D) of medical technology such as pharmaceuticals, biotechnology, agrochemicals, in vitro diagnostics, medical devices, hospital products, and genomics. More particularly, the invention relates to a method for improving the productivity of R&D by better management of activities at the program and portfolio level.

### BACKGROUND OF THE INVENTION

The productivity of research and development (R&D) is of great commercial and human importance. Pharmaceuticals and medical devices have substantially increased life expectancy and quality of life throughout the 20^{th} century. In recent years the productivity of the pharmaceutical industry has declined, creating an industry-wide problem with deep societal implications. Without these innovations, further improvement in health care will be difficult to achieve.

Traditionally, pharmaceutical companies have searched for new drugs by identifying potential targets through in-vitro and in-vivo screening. This screening is based on a range of assays that predict efficacy and safety given established medical research. Compounds emerging from these screens are then optimized for absorption characteristics, pharmacokinetics, and toxicological profile before selecting a compound for clinical development. Medical products companies undergo a similar screening process given observed physician behavior and extensive in vitro testing. All such research processes across the medical technology industry use a staged testing process, starting with in vitro assays, continuing through in vivo testing, and finally human (clinical) testing, to show sufficient evidence to allow regulatory approval for use.

Currently, there is a deficiency in the decision-making ability of organizations, in particular large companies who have many options as to how resources could be allocated. This deficiency is evident from the point of early-stage R&D through clinical development. The average cost of new drug approval is approximately $500 million for each successful product launch and typically requires more than 10 years to achieve. It is thus an ongoing objective of companies in medical technology industry to find effective ways of making more efficient decisions in order to maximize the return on their investments and more effectively deliver medical breakthroughs to society.

There are many commercially available tools that utilize predictive models to eliminate unsuccessful product concepts before substantial time and money are invested in research and development. One such model is used to predict adsorption, distribution, metabolism and excretion (ADME) properties and toxicology profiles of a drug compound. Business models such as throughput modeling and discrete event simulation have also been applied in the industry to facilitate identification of high potential products.

In particular, there is a need to determine if and when to progress products from one stage of research and development to the next, i.e., when to stop work on a particular project, and whether to pursue product candidates in parallel or in series with respect to each other. A stage gate system is generally employed to adjust priorities with the goal of ensuring that the portfolio is balanced and optimized. However, in recent years the productivity of the industry has declined in spite of these practices.

Accordingly, there remains a need for comprehensive methods to improve the effectiveness and therefore the success of the research and development (R&D) of medical technology by managing progress at the program and portfolio level. The present invention addresses this need.

### BRIEF SUMMARY OF THE INVENTION

The invention provides methods for improving the productivity of R&D by optimizing the effectiveness and maximizing the potential for success of the development of technology by managing progress at the portfolio and program level.

Key drivers of program strategy are: target success probability, compound success probability, market imperative, learning, and cost.

The invention is based on the premise that different programs need different strategies.

Application of the methods of the invention suggests that serial strategies are generally not best at either the program or portfolio level. More focused strategies are better.

Application of the methods of the invention further suggests that funding of just over half as many programs more intensively can more than double portfolio value and that expected improvements in productivity from better managing of program strategies at the portfolio level is significant.

The invention provides methods for improving the effectiveness of the research and development (R&D) decision making process within a program or across programs within a portfolio in a manner that results in higher expected value creation, for any given resource constraint across a range of back-up, investment and timing strategies, by developing a range of options for progressing one or more drug candidates starting with lead optimization or later in the development cycle; and carrying out a dynamic, probabilistic evaluation of the relative attractiveness of back-up, investment and timing strategies within a program or across programs within a portfolio. A range of options are presented and a determination of maximum value creation is made resulting in a strategy for progressing one or more drug candidates such that shareholder value is maximized.

In carrying out the methods of the invention, the dynamic, probabilistic evaluation involves a process of evaluating one or more metrics selected from the group consisting of the number of compounds that progress from preclinical to human trials, the number of successful proof of concept (POC) studies, the net present value (NPV) of cash flows over time, research and development (R&D) productivity measured as a return on incremental resource investments, cost, expected commercial value, commercial risk, and time.

In carrying out the methods of the invention, the range of options for progressing one or more drug candidates comprises a strategy selected from a parallel development strategy, a serial development strategy, and a no investment strategy which may be evaluated using various simulations.

The resource constraints that impact the effectiveness of the R&D decision making process within a program or across programs within a portfolio may be financial constraints, human resource constraints, time constraints, manufacturing, production or other functional capacity constraints.

The invention provides for maximum value creation while utilizing the most effective use of resources which is preferably reflected in an increase in shareholder value.

A determination of maximum value creation may involve ranking drug candidates or adjusting the level of funding of a given program.

At the portfolio level, maximum value creation may involve adjusting the level of funding for a given program, making a determination of cross-program dependencies, and adjusting allocation of resources.

### BRIEF DESCRIPTION OF THE DRAWINGS

FIGS. 1 A and B indicate that product launches per year have been decreasing dramatically since a peak in 1997 (FIG. 1A) while development cost per drug continues to rise (FIG. 1B).

FIG. 2 is a schematic depiction of one exemplary simulation where all compounds succeed in all phases based on very different strategy choices (designated as serial, moderate parallel, and max parallel).

FIG. 3 is a schematic depiction of a second exemplary simulation where all compounds fail after Phase I based on very different strategy choices (designated as serial, moderate parallel, and max parallel).

FIG. 4 is a schematic depiction of a third exemplary simulation where one compound (#3) succeeds and the others fail in Phase I based on very different strategy choices (designated as serial, moderate parallel, and max parallel). The comparison shows that the most productive strategy varies according to program characteristics.

FIG. 5 is a graphic depiction which illustrates the relationship between portfolio value and resource constraint, based on highest incremental value for incremental investment. The highest value portfolio, nominal portfolios, and constrained budget portfolio are indicated in the figure.

### DETAILED DESCRIPTION

Before the present invention is described, it is to be understood that this invention is not limited to particular embodiments described, as such may, of course, vary. It is also to be understood that the terminology used herein is for the purpose of describing particular embodiments only, and is not intended to be limiting, since the scope of the present invention will be limited only by the appended claims.

Unless defined otherwise, all technical and scientific terms used herein have the same meaning as commonly understood by one of ordinary skill in the art to which this invention belongs. Although any methods and materials similar or equivalent to those described herein can also be used in the practice or testing of the present invention, the preferred methods and materials are now described. All publications mentioned herein are incorporated herein by reference to disclose and describe the methods and/or materials in connection with which the publications are cited.

The publications discussed herein are provided solely for their disclosure prior to the filing date of the present application. Nothing herein is to be construed as an admission that the present invention is not entitled to antedate such publication by virtue of prior invention. Further, the dates of publication provided may be different from the actual publication dates which may need to be independently confirmed.

As will be apparent to those of skill in the art upon reading this disclosure, each of the individual embodiments described and illustrated herein has discrete components and features which may be readily separated from or combined with the features of any of the other several embodiments without departing from the scope or spirit of the present invention.

### DEFINITIONS

It must be noted that as used herein and in the appended claims, the singular forms “a”, “and”, and “the” include plural referents unless the context clearly dictates otherwise. Thus, for example, reference to “a drug” may include a plurality of drugs and reference to “the step” may include reference to one or more steps and equivalents thereof known to those skilled in the art, and so forth. Further, the term, “a set” includes a set containing only one item.

The term “accelerated”, as used herein, means a process is moved forward at a greater than average rate.

The term “attractiveness” as used herein with reference to a program or project means increasing the number of successes in each stage of the drug development process, including Phase 0 (preclinical); Phase I; Phase II; Phase III; NDA filing; etc.

The term “back-up strategy”, as used herein with reference to drug development, means a strategy designed to take the place of another, e.g., when a first strategy fails.

The term “resource constraint”, as used herein, means a constraint including but not limited to a financial constraint, a human resource constraint, a time constraint and a capacity or other functional constraint, such as manufacturing/production of active pharmaceutical ingredients (API) sufficient for various studies such as toxicology studies and clinical trials.

The term “capacity,” as used herein is the maximum amount of a given activity that can be performed in parallel, using a given resource.

The term “candidate”, as used herein, may be a development candidate or a product candidate, for which further development is required to establish viability or safety.

The term “clinical candidate” as used herein with reference to drug development refers to one or more drugs which are being considered for clinical development.

As used herein, the term “clinical benefit” refers to the fact that a new drug must show a benefit for patients that is objective and observable.

The term “competitive commercial value given success”, as used herein, refers to the potential cash flow derived from the sale of a product once it reaches the market, having succeeded in meeting all clinical and regulatory requirements. Commercial value is prospective, including considerations of market size, competitive activity and share, promotional and marketing expenses, and other necessary components of selling a medical product.

The term “development cycle”, as used herein with reference to drug development means the steps of selection, lead optimization, production, preclinical and clinical testing phases.

The term “decision criteria”, as used herein, refers to a criterion required for a change in a course of action.

The term “higher expected value creation”, as used herein means expected increases in future productivity, such as an expected increase in value for customers, employees, and investors (e.g., for the customer, by making products and providing services that customers find consistently useful; for employees by being treated respectfully and being included in decision-making; and for business by providing a high quality product that meets a need in the marketplace).

The term “increase in shareholder value”, as used herein means the expected increase in share value from one point in time to another.

The term “Investigational New Drug Application” or “IND”, is used herein to refer to an application that a drug sponsor submits to FDA before beginning clinical trials of a candidate drug in humans. The IND includes study plans and background on the drug, including its structural formula, animal test results, and manufacturing information.

The term “investment strategy”, as used herein with reference to drug development means a company's plan of distributing resources among various programs and projects.

The term “lead optimization”, as used herein, with reference to drug development means a set of experiments performed during pre-clinical and clinical development for the purpose of refining the chemical compound of interest. The goal of lead optimization is to adjust the chemical structure such that ADME is optimized, toxicity is reduced, chemical synthesis is possible with a small number of low-volatility steps, and the resulting drug product is easily formulated into the final market image form (e.g., tablet, suspension, injection).

The term “metric”, as used herein with reference to a calculated term or enumeration representing some measurable aspect that changes in some predictable way with increased human influence.

The term “no investment”, as used herein relative to a given drug development strategy means the company has opted not to expend resources on that drug development strategy.

As used herein, the term “modeling” is used with respect to an abstract representation of reality. Models are applied to variables and possible outcomes in order to aid in the process of making a decision as to the most effective course of action in order to meet a stated objective.

As used herein, the term “New Drug Application” or “NDA” is used with reference to an application requesting approval to market a new drug by the FDA, EMEA or other regulatory authority.

The term “novel target”, as used herein refers to a proposed mechanism of action that has not previously been investigated with relation to a particular medical condition. This requires that there is no evidence in the scientific literature as to the linkage of that mechanism of action with the disease state of interest. For example, a drug company may hypothesize that inhibiting the activity of enzyme X will reduce inflammation. If there has been no published research on the activity of enzyme X in inflammatory processes, even though it may be well known to be related to non-inflammatory diseases, then the inhibition of X as a treatment for inflammation would be a novel target.

The term “novel pathway”, as used herein refers to a proposed cascade of biological activity that has not previously been investigated with relation to a particular medical condition.

The term “peak revenue”, as used herein with reference to a drug means the maximum sales revenue for a given drug over a one year period.

The term “commercial value”, as used herein means the net present value of future cash flow once a product reaches market.

As used herein, the term “in parallel” refers to a process wherein multiple molecules are moved through the R&D process at the same time. It follows that, “parallel development” means that multiple molecules are developed at the same time.

The term “parallel development strategy”, as used herein relative to drug development means a range of development strategies which include a continuum of various degrees of parallelism, ranging from a strategy where the development of a second drug is initiated when the development course for a first drug is almost complete, with the development of subsequent drugs here initiated when the development course for a second, third, fourth, etc., drug is almost complete to a strategy where the development of subsequent multiple drugs is initiated at the same time and pursued in parallel.

As used herein, the term “portfolio”, refers to a group of research and development (R&D) programs.

The term “program” is used herein with reference to a particular group of related compounds focused on a particular therapeutic target. A program is typically associated with a target and a mechanism of action that is believed to result in a therapeutic effect. A program may encompass many indications or therapeutic effects, all related to the target and/or mechanism of action. For example, several different, but related chemical compounds, all of which inhibit the cyclo-oxygenase II (COX-2) enzyme, may be developed in a single program under the theory that inhibiting COX-2 will lead to reduced inflammation and therefore have a therapeutic benefit to patients suffering from arthritis. In this example, the target is reduction of inflammation for treatment of arthritis, the mechanism of action is COX-2 inhibition, and the program is the development of a set of chemically-related compounds that inhibit COX-2.

The term “project” is used herein with reference to a particular drug targeted to a particular indication or disease condition. A project is typically a subset of a program of activities, relating to the application of a specific compound to a specific set of indications or therapeutic claims. In some cases, closely related chemical compounds may be substituted in the early stages of a project. For example, a COX-2 program of activity may trigger several projects, each for a specific compound. In this example, a celecoxib project would be triggered to develop the celecoxib chemical within the goals of the COX-2 program. A similar project for valdecoxib may be triggered at the same time or a later time, sharing the goals of the COX-2 program.

As used herein, a “probabilistic system” is a system of logic or other means for the representation of and reasoning concerning uncertainty, including, as appropriate, conditional or unconditional probabilities in which numerous assessments or variables play a role.

The term “reallocating resources at the portfolio level”, as used herein means for example, moving financial resources from one program to another, by reducing the budget for one program and applying the funds to a second program. For example, such “reallocating” may involve the movement of human resources from one program to another, or the choice of performing different or additional preclinical or clinical studies.

The term “reliability,” as used herein with respect to a measurement method or calculation is the extent to which that method or calculation has been shown to correctly predict an outcome that can be independently measured.

As used herein, the terms “research options”, “development options” or “research and development options” refer to one of a number of possible compounds, product candidates and the like.

As used herein, the term “resource” is something needed for a task to be performed, for example, equipment, personnel or materials (e.g., a compound for screening).

As used herein, the term “risk” as it applies to the R&D process is expressed as the measure of the likelihood that a product candidate will progress or fail as it moves through development. Risk may be expressed at the level of overall success or failure or at each stage of the process.

As used herein, the term “selection”, refers to making a choice among the many available courses of action or product candidates.

As used herein, the term “serially” or “serial” as applied to the drug development process means a process wherein a lead molecule is moved through the R&D process until it fails, then the next one is started. It follows that, “serial development” means that only a single molecule is developed until the decision is made to terminate the development process, then another molecule is moved into the R&D pipeline.

The term “timing strategy”, as used herein relative to drug development, means a strategy based on the relative timing of the development process for one or more drug candidates.

The term “validated target”, as used herein, means that it has been shown that modulation of the particular target (e.g., a cellular receptor) is associated with improving a particular disease condition. For example, it has been shown through extensive in vitro and in vivo research that the modulation of the COX-2 enzyme reduces inflammation in the joints, leading to an alleviation of osteoarthritis. Often in vitro studies are used for initial target validation, although clinical results in animal models, or preferably in humans, is the gold standard.

The term “validated pathway”, as used herein, means a specific biological pathway that has been demonstrated to be associated with a particular disease condition. For example, it has been shown that the cytokine cascade is linked to inflammation throughout the body. The pathway and order of biological activity can be substantiated, as can the implications of modulating each member of the cascade.

The R&D Process and Associated Problems in Maximizing Expected Value

Pharmaceutical companies often have multiple opportunities for development of product candidates.

Financial factors and probability of success are key elements that are analyzed in order to prioritize drug candidates and allocate resources effectively to result in optimal value creation.

Financial factors that play a role in prioritization of drug candidates include expected peak sales and competitiveness of the market.

Additional factors that contribute to probability of success include variables applied in lead optimization, such as: (1) the probability of success for each candidate in a given program; (2) the probability of success or failure for a given target; (3) whether the target is validated or not; (4) whether the pathway is known and is or is not validated; and (4) whether the target and/or pathway is novel.

The methods of the present invention may be applied at any stage in the development of a given program and/or across programs within a portfolio. It will be understood that the analysis is not a static process and the evaluation of a given program and/or across portfolios is typically repeated at certain intervals, e.g., every 6 months, once per year, etc.

A given pharmaceutical company has a portfolio of R&D programs. R&D includes a series of stages from “lead optimization”, preclinical testing, a Phase 1 clinical trial, a Phase II clinical trial, a Phase III clinical trial, and submission to the FDA for regulatory approval.

Product candidates may be selected after results are obtained from a Phase 1 clinical trial indicating the drug has an acceptable safety profile. This process may be referred to as early lead optimization. Late lead optimization starts in the research phase and continues into the period when the Phase II trial is being conducted.

Early in the research and development process, the work in a given area may be referred to as a “program”. A program includes multiple molecules or drug candidates. As the program matures, if successful, the work is referred to various project, for example, a specific molecule or drug candidate with a limited number of clinical indications.

In general pharmaceutical companies carry out serial R&D on optimized lead drug or product candidates. The present invention is based on the observation that applying a consistent strategy of serial development to drug or product candidates will not lead to optimal value creation.

The invention provides a means to improve the decision-making process such that drug or product candidates are developed in a manner which is optimized in terms of resource allocation and corresponding value creation.

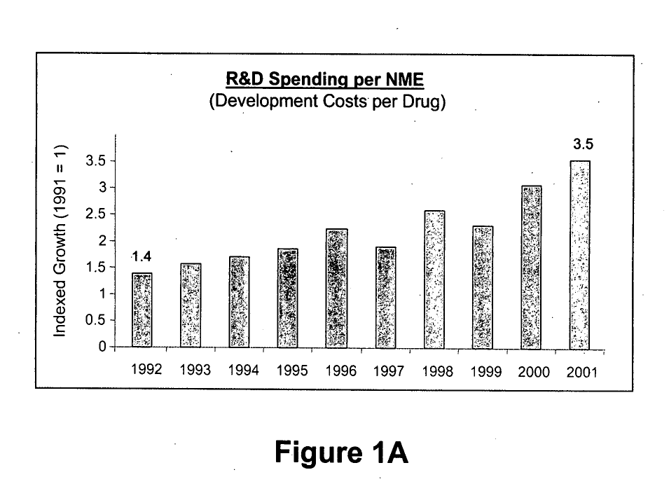

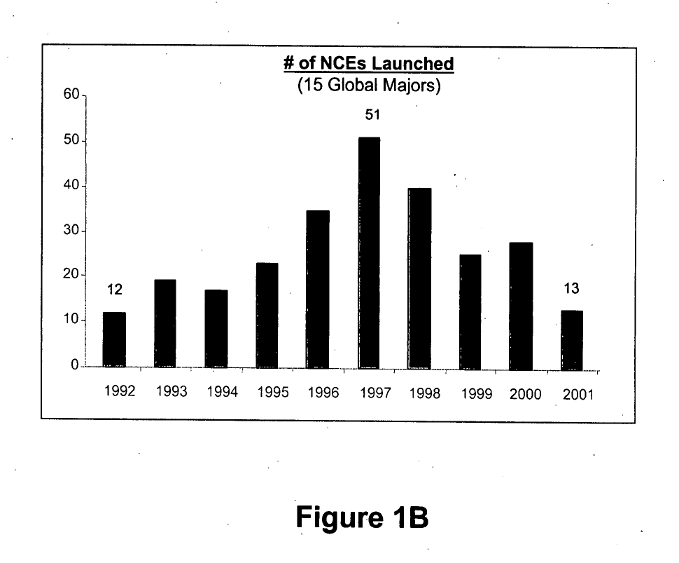

As shown in FIGS. 1A and B, product launches per year have been decreasing dramatically since a peak in 1997, while development costs per drug continues to rise.

In one example, a pharmaceutical company establishes a program at a cost of $20 to 40 million that produces multiple molecules in order to get to the point of being capable of “producing” a molecule to address a particular target (e.g. beta-amyloid plaques associated with Alzheimer's Disease). In order to produce one or more candidate drug molecules for preclinical testing (in animals), an additional $5-10 million is needed per drug candidate.

Following preclinical testing, a number of molecules fall into the category of “clinical candidates”. Further testing may be carried out, as follows:

### (1) Molecules that succeed preclinically progress to clinical testing in humans;

### (2) Molecules that are non-toxic (Phase 1 Clinical Trial) proceed to testing for small-scale “proof-of-concept” efficacy (Phase 2 Clinical Trial);

### (3) Molecules that succeed in Phase 2 proceed to large-scale statistical proof of efficacy (Phase 3 Clinical Trial); and

### (4) Molecules that succeed in Phase 3 which are subsequently submitted for FDA approval.

R&D is a series of stages from lead optimization to preclinical testing through clinical trials. Extensive preclinical studies (Phase 0) are generally conducted, followed by candidate selection and testing in a Phase I clinical trial to determine safety. Proof of concept relative to efficacy is evaluated in one or more Phase II clinical trials, followed by large scale testing in one or more Phase III clinical trials and submission of an application for regulatory approval.

The most commonly performed clinical trials evaluate new drugs, medical devices, or diagnostics under controlled conditions as required for regulatory approval by the FDA, EMEA, or other regulatory authority. Trials may be designed to assess the safety and efficacy of an experimental therapy, to assess whether the new therapy is better than the current standard therapy, or to compare the efficacy of two standard or current therapies (interventions).

The study design that provides the most compelling evidence of a causal relationship between the treatment and the effect is a randomized controlled trial. Phase II and III drug trials are typically designed to be randomized, double-blind, and placebo-controlled. In such studies, each subject in the trial is randomly assigned to receive a particular treatment, which might be the placebo. The number of patients enrolled in the study also has a large bearing on the ability of the trial to reliably detect an effect of a treatment.

The drug-development process will normally proceed through all stages of clinical development. If the drug successfully passes through the first three phases, it is typically approved by the Food and Drug Administration (FDA).

Phase I trials are the first-stage of testing in human subjects. Normally a relatively small (20-80) group of healthy volunteers or patients (i.e., HIV or cancer patients) are enrolled in the trial which is used to assess the safety, tolerability and pharmacokinetics of a candidate therapy. Phase I trials may also include dose-ranging studies so that doses for clinical use can be refined. A drug is dropped if the results of the Phase I trial show toxic effects.

Companies may carry out a combined Phase I/II trial with the goal of obtaining both efficacy and toxicity data.

Following a positive result from a Phase I trial, a Phase II trial is typically performed on a larger group of volunteers and/or patients. Phase II studies are sometimes divided into Phase IIA and Phase IIB. Phase IIA is specifically designed to assess dosing requirements, whereas Phase IIB is specifically designed to study efficacy.

Phase III studies are large, double-blind, randomized, controlled trials on large groups of patients and serve as the basis for a definitive assessment of the efficacy of a drug candidate.

If the results of a Phase III trial are positive and the drug proves to be safe and effective, the results of human and animal trials as well as information on how the drug is manufactured are summarized in a large document which is submitted to the FDA. This regulatory submission, which may take the form of a 1 New Drug Application (NDA) provides a comprehensive description of the methods and results of human and animal studies, manufacturing procedures, formulation details and shelf life.

The FDA typically takes one to two years to complete the review process and approve a drug, although under the Prescription Drug User Fee Act (PDUFA), the FDA is required to respond to filed NDAs within 10 months.

### The R&D Process

In order for the R&D processes to be efficient and successful, management must determine if it is best to proceed serially (by moving one lead drug candidate through the various stages of development as set forth above until it fails, then start the next one) or proceed with multiple drug candidates in parallel. If the company proceeds in parallel for multiple programs, resources must be allocated across the various programs. If the parallel strategy is applied the company must determine how many drug candidates should proceed in parallel and at which stages the results should be evaluated.

Typical questions that arise include the following:
How many programs should be started?
How far should multiple programs progress?
At what stage should they be evaluated/reevaluated?
What are the factors that suggest allocation of greater resources to a particular program versus another?

The industry norm for drug development is to proceed serially, or in some cases with a single backup. Historically, management has found this the easiest way to operate when faced with the numerous and complex variables associated with the process of determining which candidate drugs to develop and on what time frame.

Serial development has been shown to result in an average delay of 1 to 3 years in time to market and a lower probability of getting to market at all relative to alternative strategies. Application of a serial development strategy does include decision making at each stage of development.

The present invention provides a means to evaluate the complex matrix of variables associated with the drug development process across programs and portfolios and provides a means to determine which candidate drugs to develop and the relative time frame for such development, in a manner that results in increased likelihood of bringing a successful product to market and an increase in shareholder value.

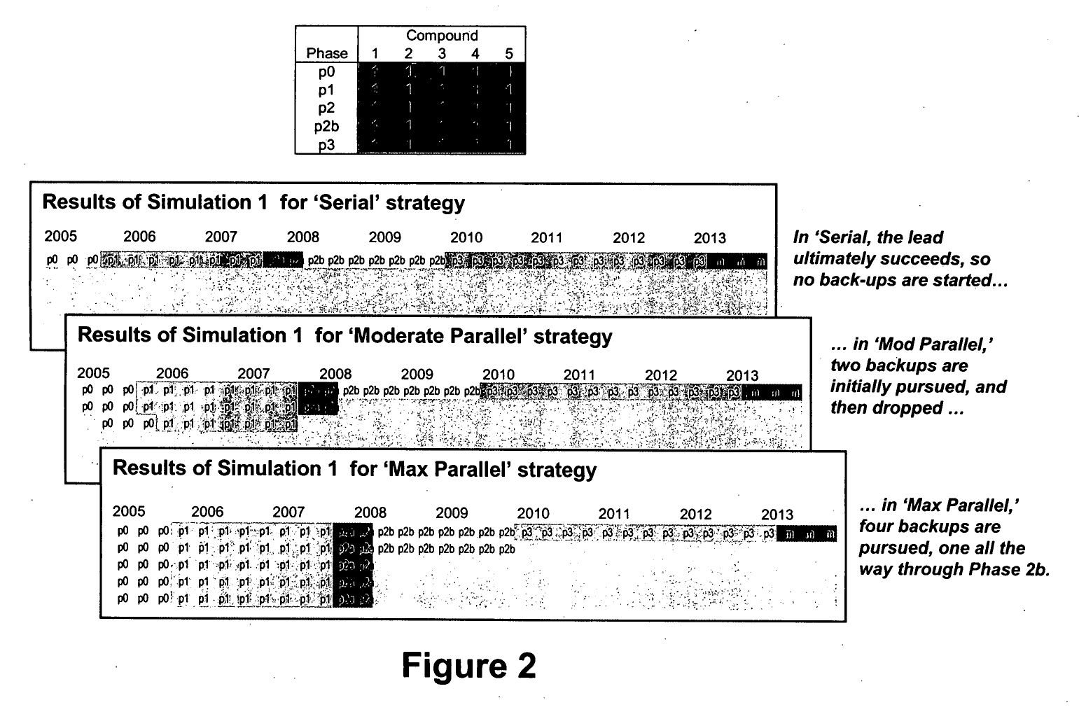

The invention makes use of a management control strategy table, which provides a platform for specification of thousands of alternative program strategies for purposes of evaluation and serves as the basis from which optimized decision making arises (FIGS. 2-4). Some components of the system of the invention as applied to the testing of alternative program strategies include consideration of: (1) an early-development alternatives strategy; (2) a Phase 0 start policy; and (3) a back-up policy. All settings are adjustable and any strategy of interest can be investigated using the system of the present invention.

Early-Development Strategy Alternatives.

Although early drug candidate development strategies should all be viewed as a continuum, category descriptions may be assigned for purposes of designating strategy alternatives. Exemplary category alternatives include a continuum of various degrees of parallelism, ranging from a strategy: (a) where the development of a second drug is initiated when the development course for a first drug is almost complete, with the development of subsequent drugs initiated when the development course for a second, third, fourth, etc., drug is almost complete, to a strategy (b) where the development of subsequent multiple drugs is initiated at the same time and pursued in parallel.

An alternative approach is a serial strategy defined herein as a strategy alternative where a single lead drug candidate is moved through the various stages of development until it fails, then the next one is started.

As indicated in FIGS. 2-4, different program characteristics drive very different strategy choices.

Phase 0 Start Policy.

Phase 0 start policies involves consideration of the lag time between starting Phase 0 (preclinical development) for a series of drug candidates.

Back-Ups Policy.

A back-ups policy involves consideration of the maximum number of back-ups by lead-compound phase.

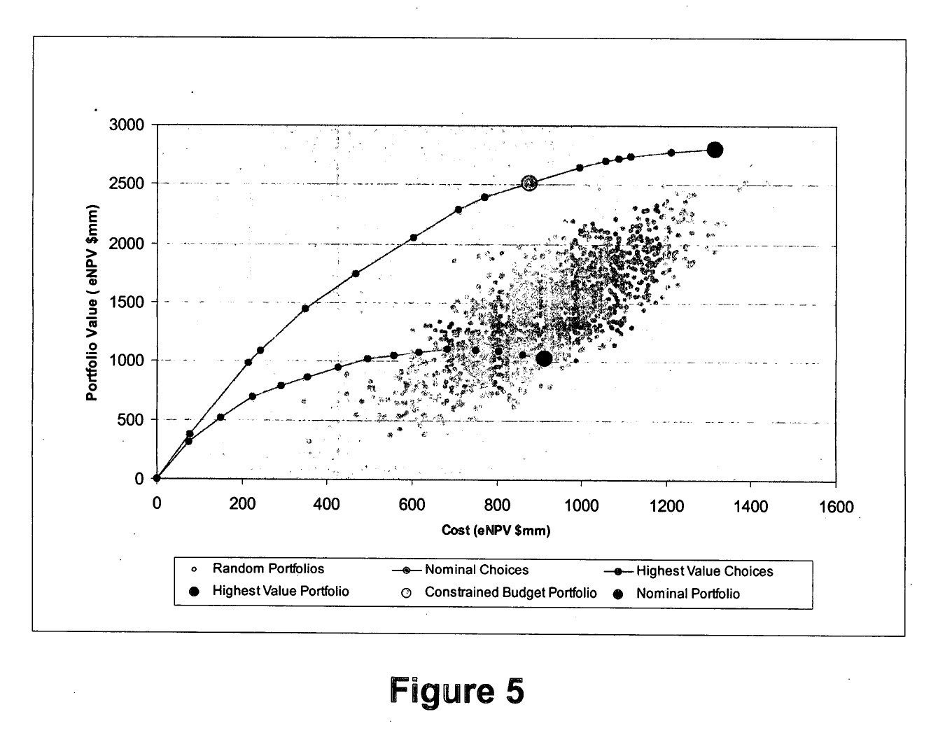

Another factor that plays into optimal decision-making is commercial value given success, i.e., how big is the market if a successful drug were to be identified. As shown in FIG. 5, commercial variability within program types is treated as a separate dimension.

As indicated in Table 2 (below), results of test simulations using the system of the invention indicate that for validated targets in highly competitive markets, max parallel is usually the most productive strategy. However, the most productive strategy varies according to program characteristics.

The terms used in Tables 2 and 3 are defined as follows: shareholder value or “SHV” is defined as expected net present value (“NPV”) of future cash flows; “COST” is defined as the expected cost of a program in terms of net present value (“NPV”); productivity or “PROD” is defined as SHV/COST; proof of concept or “POC” is defined as the probability that a particular program will be successful as determined by the outcome of a small scale efficacy study in humans (i.e., a Phase IIa clinical trial); “MARKET is defined as the size of the market for a particular drug; “TIME” is defined as the expected time to launch from the time of the initial resource expenditure for the program; and “PEAK” is defined as the peak revenue in terms of millions of dollars ($) per year.

TABLE 2
Validated Targets In Highly Competitive Markets

| Serial | Accel | Mod P | Max P | |
|---|---|---|---|---|
| 80 | 250 | 250 | 310 | SHV |
| 1.3 | 1.9 | 1.9 | 2.3 | Prod |
| 37% | 66% | 66% | 66% | POC |
| 20% | 44% | 44% | 43% | Market |
| 2,015.1 | 2,014.7 | 2,014.7 | 2,014.3 | Time |
| 833 | 889 | 889 | 958 | Peak |
| 63 | 131 | 131 | 138 | Cost |

As indicated in Table 3, results of test simulations using the system of the invention indicate that for novel targets in markets that are less competitive initially, accelerated POC (proof of concept) is usually the most productive strategy.

TABLE 3
Novel Targets In Markets That Are Less Competitive Initially.

| Serial | Accel | Mod P | Max P | |
|---|---|---|---|---|
| 74 | 102 | 124 | 93 | SHV |
| 1.1 | 1.6 | 1.3 | 1.0 | Prod |
| 13% | 12% | 13% | 11% | POC |
| 6% | 6% | 7% | 5% | Market |
| 2,018.1 | 2,016.9 | 2,015.0 | 2,014.2 | Time |
| 2,627 | 2,741 | 2,910 | 2,982 | Peak |
| 69 | 63 | 93 | 92 | Cost |

As indicated by FIGS. 2 through 4, the most productive strategy varies according to program characteristics.

### EXAMPLES

The following examples are offered to illustrate, but not to limit the claimed invention.

### Example 1

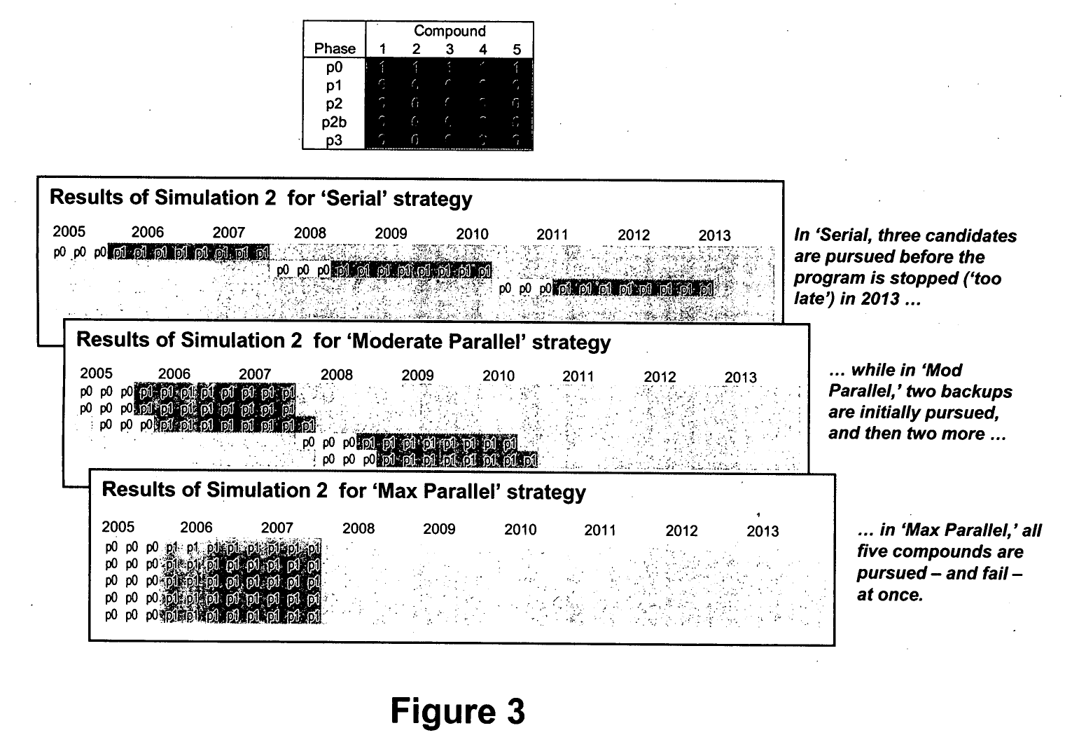

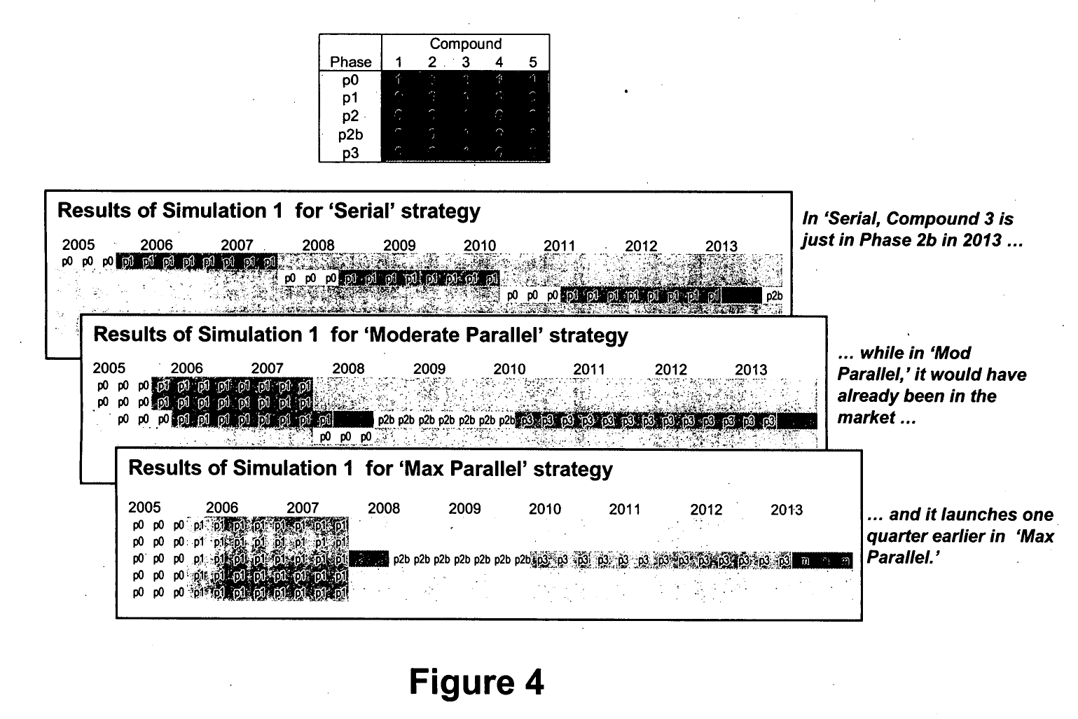

A simulation approach enabled considering the thousands of possible scenarios for each strategy. In one example, 6̂5×2=15,552 scenarios may be sampled by simulation according to the assigned probabilities (green cells potentially change in each simulation).
In a first simulation, all compounds succeed in all phases (FIG. 2). When a Serial strategy is applied to the first simulation, the lead ultimately succeeds, so no back-ups are started; while when a Mod Parallel strategy is applied, two back-ups are initially pursued, and then dropped and when a Max Parallel strategy is applied, four back-ups are pursued, one all the way through Phase 2b.
In a second simulation, all compounds fail after Phase 1 (FIG. 3). When a Serial strategy is applied to the second simulation, three candidates are pursued before the program is stopped (‘too late’); while when a Mod Parallel strategy is applied, two back-ups are initially pursued, and then two more, and when a Max Parallel strategy is applied, all five compounds are pursued and fail, at the same time.
In a third simulation, one compound, designated-Compound 3, succeeds and others fail in Phase 1 (FIG. 4). Based on a 2005 start date, when a Serial strategy is applied to the third simulation, Compound 3 is just in Phase 2b in 2013; while when a Mod Parallel strategy is applied, Compound 3 would have already been on the market in 2013, and when a Max Parallel strategy is applied, it launches one quarter earlier.

### Example 2

In one specific application of the methods of the invention, a “start-up” pharmaceutical company has 14 programs it could fund. The drug candidates that serve as the basis for the programs may be directed to validated targets (validated by the company itself or others); validated pathways or novel targets/pathways.

Each program team has proposed a serial strategy, however, there is just enough money to fund this approach for the next several years. Application of the methods of the invention to this scenario, indicates that managing program strategies at the portfolio level will add value. The results of such an analysis show that, as compared to an all serial case, management can add value by reallocating resources at the portfolio level. The problem may be analyzed by a consideration of the fact that management has six billion portfolio choices to consider. 5 strategy choices for each of 14 programs=5̂14 (6 Billion) portfolio choices. See FIG. 5, which shows a clear correlation between cost and value at the portfolio level, by illustrating 1,500 of the 6 billion possible portfolio choices. The “All Serial” portfolio has mid-range cost but lower expected value than most while when the methods of the current invention are applied and program strategies are managed at the portfolio level, the expected value more than doubles the portfolio value for less cost.

Application of the methods of the present invention provides a means to select a scenario that yields a 2.5× increase in portfolio value which is gained by pursuing fewer programs in a smarter and more aggressive way (FIG. 5).

In application of the methods of the invention, resource allocation shifts toward validated targets, but smart pursuit of novel targets and validated pathways remains essential and portfolio choices are built up based on highest incremental value for incremental investment (FIG. 5).

Dependent upon the level of funds available, programs on the margin can be readily identified.

What is claimed is:

1. A method of improving the effectiveness of the research and development (R&D) decision making process within and across programs in a manner that results in higher expected value creation for any given resource constraint across a range of (a) back-up, (b) investment and (c) timing strategies, comprising:
designing an R&D strategy by developing a range of options for progressing one or more drug candidates starting with lead optimization or later in the development cycle and carrying out a dynamic, probabilistic evaluation of the relative attractiveness of said back-up, investment and timing strategies within the program, wherein a range of options are presented and a determination of maximum value creation is made resulting in a strategy for progressing one or more drug candidates within said program.

2. The method of claim 1, wherein said dynamic, probabilistic evaluation involves a process comprising an evaluation of one or more metrics selected from the group consisting of,
(a) the number of compounds that progress from preclinical to human trials;
(b) the number of successful proof of concept (POC) studies;
(c) the net present value (NPV) of cash flows over time;
(d) research and development (R&D) productivity measured as a return on incremental resource investments;
(e) cost;
(f) expected commercial value;
(g) commercial risk; and
(h) time.

3. The method of claim 2, wherein said metric is the number of successful proof of concept (POC) studies.

4. The method of claim 2, wherein said metric is the net present value (NPV) of cash flows over time.

5. The method of claim 2, wherein said metric is research and development (R&D) productivity measured as a return on incremental resource investments.

6. The method of claim 2, wherein said metric is cost.

7. The method of claim 2, wherein said metric is expected commercial value.

8. The method of claim 2, wherein said metric is time.

9. The method of claim 1, wherein said range of options for progressing one or more drug candidates comprises a strategy selected from a parallel development strategy, a serial development strategy, and no investment.

10. The method of claim 9, wherein said option for progressing one or more drug candidates is a parallel development strategy.

11. The method of claim 9, wherein said option for progressing one or more drug candidates is a serial development strategy.

12. The method of claim 9, wherein said option for progressing one or more drug candidates involves no investment.

13. The method of claim 1, wherein said strategy comprises simulation of a range of options for progressing one or more drug candidates.

14. The method of claim 1, wherein said range of options for progressing one or more drug candidates is evaluated at the preclinical stage (Phase 0).

15. The method of claim 1, wherein said range of options for progressing one or more drug candidates is evaluated at the stage of starting a Phase I clinical trial.

16. The method of claim 1, wherein said range of options for progressing one or more drug candidates is evaluated at the stage of starting a Phase II clinical trial.

17. The method of claim 1, wherein said range of options for progressing one or more drug candidates is evaluated at the stage of starting a Phase III clinical trial.

18. The method of claim 1, wherein said resource constraints are selected from the group consisting of financial constraints, human resource constraints, time constraints and manufacturing, production or another functional capacity constraint.

19. The method of claim. 18, wherein said resource constraint is manufacturing or production of sufficient active pharmaceutical ingredients (API) for a given drug candidate to complete a toxicology study or clinical trial.

20. The method of claim 18, wherein said resource constraint is a financial constraint.

21. The method of claim 18, wherein said resource constraint is a time constraint.

22. The method of claim 1, wherein maximum value creation comprises the most effective use of resources.

23. The method of claim 22, wherein said resources are financial resources.

24. The method of claim 22, wherein said resources are human resources.

25. The method of claim 1, wherein maximum value creation comprises an increase in shareholder value.

26. The method of claim 1, wherein said determination of maximum value creation involves ranking drug candidates.

27. The method of claim 1, wherein said determination of maximum value creation involves adjusting the level of funding of a given program.

28. A method of improving the effectiveness of the research and development (R&D) decision making process across programs in a manner that results in higher expected value creation, for any given resource constraint across a range of (a) back-up, (b) investment and (c) timing strategies, comprising:
carrying out a dynamic, probabilistic evaluation of the relative attractiveness of said back-up, investment and timing strategies between programs, wherein a range of options are presented and a determination of maximum value creation is made, resulting in a strategy for progressing a portfolio of programs.

29. The method of claim 28, wherein said dynamic, probabilistic evaluation involves a process comprising a evaluation of one or more metrics selected from the group consisting of,
(a) the number of compounds that progress from preclinical to human trials;
(b) the number of successful proof of concept (POC) studies;
(c) the net present value (NPV) of cash flows over time;
(d) research and development (R&D) productivity measured as a return on incremental resource investments;
(e) cost;
(f) expected commercial value;
(g) commercial risk; and
(h) time.

30. The method of claim 29, wherein said metric is the number of successful proof of concept (POC) studies.

31. The method of claim 29, wherein said metric is the net present value (NPV) of cash flows over time.

32. The method of claim 29, wherein said metric is research and development (R&D) productivity measured as a return on incremental resource investments.

33. The method of claim 29, wherein said metric is cost.

34. The method of claim 29, wherein said metric is expected commercial value.

35. The method of claim 29, wherein said metric is time.

36. The method of claim 28, wherein said range of options for progressing one or more programs comprises a strategy selected from the group consisting of a parallel development strategy, a serial development strategy and no investment.

37. The method of claim 36, wherein said option for progressing one or more drug candidates is a parallel development strategy.

38. The method of claim 36, wherein said option for progressing one or more drug candidates is a serial development strategy.

39. The method of claim 36, wherein said option for progressing one or more drug candidates involves no investment.

40. The method of claim 28, wherein said strategy comprises simulation of a range of options for progressing one or more drug candidates.

41. The method of claim 28, wherein said resource constraints are selected from the group consisting of financial constraints, human resource constraints, time constraints and manufacturing, production or another functional capacity constraint.

42. The method of claim 41, wherein said resource constraint is manufacturing or production of sufficient active pharmaceutical ingredients (API) for a given drug candidate to complete a toxicology study or clinical trial.

43. The method of claim 41, wherein said resource constraint is a financial constraint.

44. The method of claim 41, wherein said resource constraint is a time constraint.

45. The method of claim 28, wherein said range of options for progressing one or more drug candidates is evaluated at the preclinical stage (Phase 0).

46. The method of claim 28, wherein said range of options for progressing one or more drug candidates is evaluated at the stage of starting a Phase I clinical trial.

47. The method of claim 28, wherein said range of options for progressing one or more drug candidates is evaluated at the stage of starting a Phase II clinical trial.

48. The method of claim 28, wherein said range of options for progressing one or more drug candidates is evaluated at the stage of starting a Phase III clinical trial.

49. The method of claim 28, wherein maximum value creation comprises the most effective use of resources.

50. The method of claim 28, wherein maximum value creation comprises an increase in shareholder value.

51. The method of claim 28, wherein said determination of maximum value creation involves ranking drug candidates.

52. The method of claim 28, wherein said determination of maximum value creation involves adjusting the level of funding for a given program.

53. The method of claim 28, further comprising a determination of cross-program dependencies

54. The method of claim 53, further comprising an evaluation of the effect of cross-program dependencies selected from limited financial resources and limited human resources.

55. The method of claim 54, wherein said cross-program dependencies are due to limited financial resources.

56. The method of claim 54, wherein said cross-program dependencies are due to limited human resources.

57. The method of claim 28, further comprising adjusting allocation of financial resources.

58. The method of claim 28, further comprising adjusting allocation of human resources.

59. The method of claim 28, further comprising evaluating available resources to determine what is the most effective use thereof and making a determination as to which programs to fund.

60. The method of claim 49, wherein the most effective use of resources comprises shifting resources from one program to another.

61. The method of claim 28, further comprising gaining organizational alignment and affecting effective implementation including, but not limited to aspects selected from the group consisting of organizational design, design processes, decision and resource allocation processes, supporting systems including software with linkages to other companies including processes such as strategic planning and budgeting resulting in higher expected value creation.

62. A method of measuring the prospective productivity of Research and Development that is defined by:
(a) probabilistic simulation of key underlying uncertainties such as probabilities of technical success, time, and costs by phase and commercial value results given success;
(b) expected net present value of product life-cycle costs, revenue, and other components of value; and
(c) dynamic decision-making as uncertainty resolves (or learning occurs) according to alternative strategy or decision rules to be tested.
